(19) United States
(12) Patent Application Publication
(10) Pub. No.: US 2005/0032943 A1
(43) Pub. Date: Feb. 10, 2005

(54) Polyamide-based concentrated solution, use thereof in methods for making polyamide compositions and resulting compositions

(76) Inventors: Giuseppe Di Silvestro, Lentate Sul Seveso (IT); Franco Speroni, Ceriano Laghetto (IT); Cuiming Yuan, Milano (IT); Haichun Zhang, Saronno (IT)

Correspondence Address: BURNS DOANE SWECKER & MATHIS L L P, POST OFFICE BOX 1404, ALEXANDRIA, VA, 22313-1404, US

(21) Appl. No.: 10/311,546

(22) PCT Filed: Jun. 15, 2001
(86) PCT No.: PCT/EP01/06726

(30) Foreign Application Priority Data
Jun. 16, 2000 (FR) 0007704

(51) Int. Cl. C08K 5/34; C08K 3/18

(52) U.S. Cl. 524/100; 524/430

(57) ABSTRACT

The invention concerns concentrated solutions based on polyamide used for introducing an additive into a thermoplastic matrix. The concentrated solutions comprise a matrix and an additive, the matrix being a modified polyamide having a star-shaped or H-shaped structure.

The invention relates to concentrated polyamide-based solutions used for introducing an additive into a thermoplastic matrix. The concentrated solutions comprise a matrix and an additive, the matrix being a modified polyamide having a star or H structure.

The present invention relates to novel concentrated polyamide-based solutions for improving the quality of the compositions obtained using these solutions or for improving the performance of the processes for obtaining them.

To manufacture polyamide-based articles, for example moulded articles, films, yarns, fibres or filaments, compositions are mostly used which comprise the polyamide and additives. These additives are intended to modify and improve the behaviour of the polyamide with regard to certain properties. Mention may be made, for example, of heat or light stability, coloration, thermomechanical properties, fire retardancy.

These additives may also aid the manufacture of the compositions and articles obtained therefrom. They may, for example, be catalysts or lubricants.

To produce polymer compositions containing additives, it is common practice to use concentrated thermoplastic solutions. These concentrated solutions are compositions which comprise a thermoplastic matrix and the additive, preferably in a relatively high concentration, and are intended to be melt-blended with the polymer to which it is desired to add the additive. The concentrated solution is in general introduced in the form of granules into an extruder.

This method of incorporation has several advantages. It may allow compositions very dilute in terms of additive to be obtained with good control and it may allow several types of composition to be easily produced on the same line, without it being necessary to adapt the line to the form of the additive. All these advantages are known to those skilled in the art.

Thus, there are commercially available concentrated thermoplastic solutions comprising useful additives for producing polymer compositions. These concentrated solutions differ from one another by the nature of the matrix and the nature and concentration of the additives. In some cases, the concentrated solutions are prepared as intermediate products for the companies selling final compositions or finished articles.

To obtain the best possible compositions, it is generally preferred for the matrix of the concentrated solution used for incorporating the additives to be of the same nature, or of as similar a nature as possible, as the polymer on which the final composition is based. Thus, it is known to use matrices made of nylon-6 or nylon-6,6 for the incorporation of additives into compositions based on nylon-6 or nylon-6,6. This practice is widely used in the fields of engineering plastics and the manufacture of spun articles.

Firstly, the use of concentrated solutions entails additional production costs; it involves several melt-blending processes, one for producing the masterbatch and one for incorporating it into the polymer of the composition. The manufacture and the use of highly concentrated solutions limits the additional cost.

It is a first object of the invention to provide novel polyamide-based concentrated solutions with a high concentration of additives.

Secondly, certain additives require special conditions to incorporate them into the matrix of the concentrated solution and then into the final compositions. These are, for example, additives which are unstable to the heat induced by the heating and/or the shear produced during incorporation. From another standpoint, the heat and/or shear may cause the polymer to undergo degradation. In order to limit these problems, it is known to use special matrices such as EVA. This polymer is not very compatible with polyamides. It is also known to use nylon-6, -6,6 and -6,10 random copolymers. The cost of these matrices is high. In the case of the manufacture of compositions based on nylon-6 or nylon-6,6, these also result in the incorporation of different repeat units, which may have a low degree of compatibility with the polyamide and modify the properties of the polyamide.

It is a second object of the invention to provide masterbatches making it possible to obviate these difficulties, by operating at a lower temperature and/or with less shear, using a matrix based on polyamide units and to introduce the minimum amount of units not consistent with the polymer.

The invention therefore provides a concentrated solution comprising a polyamide-based matrix and an additive chosen from fire retardants, pigments, dyes, stabilizers, lubricants, catalysts, processing aids, nucleating agents and mixtures thereof, characterized in that the matrix is a macromolecular compound comprising
star- or H-configured macromolecular chains comprising a core and at least three polyamide branches linked to the core,
optionally, linear polyamide macromolecular chains,
   the weight ratio of the star-configured macromolecular chains to the sum of the star-configured and linear macromolecular chains being between 1 and 0.1 and in that the melt flow index of the matrix measured according to the ISO 1133 standard at 275° C. under a load of 100 g is greater than 20 g/l 0 min.

The concentrated polyamide solutions according to the invention are industrial products usually packaged in granule form and intended to be used for the manufacture of polymer compositions containing additives. These compositions are obtained by melt-blending a thermoplastic polymer with the concentrated solution, for example using an extruder.

The compositions obtained are formed after the melt-blending phase. According to a first process, the composition is formed into granules, which will subsequently be remelted for a final forming operation. According to a second process, the compositions undergo a final forming operation just after the blending phase, without there being any intermediate solidification or remelting. As examples of final forming operations, mention may be made of injection moulding, extrusion and spinning.

The concentrated solutions comprising a thermoplastic matrix and an additive are generally intended to be used for manufacturing polymer compositions containing additives. In general, the concentrated solutions are highly concentrated in terms of additives compared with the polymeric compositions for which they are intended, these compositions generally being very dilute in terms of additives. For most additives, it may be considered that a concentrated solution comprises at least 10% by weight of additive.

According to a preferred characteristic of the invention, the proportion by weight of additive in the concentrated solution is greater than or equal to 10%.

The concentrated solution according to the invention comprises an additive and a matrix, characterized in that the matrix is a macromolecular compound whose characteristics were mentioned above. The invention also relates to the use of these macromolecular compounds as the matrix of a concentrated polyamide solution.

The matrix of the concentrated solution comprises star- or H-configured macromolecular chains. Such chains, or polymers comprising such chains, are described, for example in documents FR 2 743 077, FR 2 779 730, U.S. Pat. No. 5,959,069, EP 0 632 703, EP 0 682 057 and EP 0 832 149. These compounds are known for having a better melt flow than linear polymers. The melt flow index of the matrix, measured according to the ISO 1133 standard at 275° C. under a load of 100 g is greater than 20 g/10 min.

The star- or H-configured macromolecular chains are obtained by using a multifunctional compound having at least three reactive functional groups, all the reactive functional groups being identical. This compound can be used as a comonomer in the presence of other monomers in a polymerization process. It can also be brought into contact with a polyamide during an extrusion step.

The star- or H-configured macromolecular chains comprise a core and at least three polyamide branches. The branches are linked to the core by a covalent bond via an amide group or a group of another kind. The core is an organic or organometallic chemical compound, preferably a hydrocarbon compound which possibly includes heteroatoms and to which the branches are linked. The branches are polyamide chains. They may be branched, this being especially the case in H structures. The polyamide chains constituting the branches are preferably of the type of those obtained by the polymerization of lactams or amino acids, for example of the nylon-6 type.

Optionally, the matrix comprises, apart from the star chains, linear polyamide macromolecular chains. The ratio by weight of the amount of star chains in the matrix to the sum of the amounts of star and linear chains is between 1 and 0.1, limits inclusive. It is preferably between 0.9 and 0.6.

According to a first process, the matrix may be obtained by copolymerization starting with a monomer mixture comprising:
a) a multifunctional compound comprising at least three reactive functional groups chosen from amines, carboxylic acids and derivatives thereof, all the reactive functional groups being identical,
b) monomers of the following general formulae (IIa) and (IIb):
   X—R₂Y (IIa)
   or 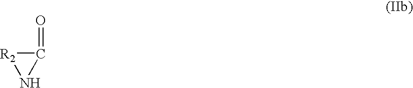
c) optionally, monomers of the following general formula (III):
   Z—R₃—Z (III)
   in which:
Z represents a functional group identical to that of the reactive functional groups of the multifunctional compound
   R₂, R₃, which are identical or different, represent substituted or unsubstituted, aliphatic, cycloaliphatic or aromatic hydrocarbon radicals containing from 2 to 20 carbon atoms and possibly including heteroatoms,
   Y is a primary amine functional group when X represents a carboxylic acid functional group, or
   Y is a carboxylic acid functional group when X represents a primary amine functional group.

The term “carboxylic acid” is understood to mean carboxylic acids and derivatives thereof, such as acid anhydrides, acid chlorides, esters, etc. The term “amine” is understood to mean amines and derivatives.

Such production processes are described in documents FR 2 743 077 and FR 2 779 730.

If a comonomer c) is used, the polymerization reaction (polycondensation) is advantageously carried out until thermodynamic equilibrium is achieved.

The monomer mixture may include other compounds, such as chain stoppers, catalysts, or additives.

This process results in the formation of star-configured macromolecular chains and, optionally, linear macromolecular chains. The percentage ratio PS of the number of star-configured macromolecular chains to the total number of chains is determined by the following formulae:
if the multifunctional compound has 4 reactive functional groups:

$$PS = \frac{4 {T}_{0} {X}_{d}^{3} ( 1 - {X}_{d} ) + {T}_{0} {X}_{d}^{4}}{\begin{matrix}{N}_{0} ( 1 - {X}_{d} ) - 2 {R}_{0} {X}_{d} - 4 {T}_{0} {X}_{d} + \\ {R}_{0} [ 1 - {( 1 - {X}_{d} )}^{2} ] + {T}_{0} [ 1 - {( 1 - {X}_{d} )}^{4} ]\end{matrix}} \times 100$$

$$\text{in which:}$$

$${X}_{d} = 1 - \frac{[ COOH ]}{2 {R}_{0} + 4 {T}_{0} + {N}_{0}}$$

if the reactive functional groups are acid functional groups;

$${X}_{d} = 1 - \frac{{N}_{0} - [ NH2 ]}{2 {R}_{0} + 4 {T}_{0} + {N}_{0}}$$

if the reactive functional groups are amine functional groups;
T₀ represents the number of moles of multifunctional compound;
N₀ represents the initial number of moles of monomer of formula (IIa) or (IIb);
R₀ represents the initial number of moles of 5monomer of formula (III);
if the multifunctional compound has 3 reactive functional groups:

$$PS = \frac{{T}_{0} {X}_{d}^{3}}{{N}_{0} ( 1 - {X}_{d} ) - {R}_{0} {X}_{d} - 3 {T}_{0} {X}_{d} + {T}_{0} [ 1 - {( 1 - {X}_{d} )}^{3} ]} \times 100$$

in which:
if the reactive functional groups are acid functional groups;

$${X}_{d} = 1 - \frac{[ COOH ]}{2 {R}_{0} + 3 {T}_{0} + {N}_{0}}$$

if the reactive functional groups are amine functional groups;

$${X}_{d} = 1 - \frac{{N}_{0} - [ NH2 ]}{2 {R}_{0} + 3 {T}_{0} + {N}_{0}}$$
T₀ represents the number of moles of multifunctional compound;
N₀ represents the initial number of moles of monomer of formula (IIa) or (IIb);
R₀ represents the initial number of moles of monomer of formula (III).

According to a second process, the matrix comprises H-configured macromolecular chains, the matrix being obtained by copolymerization starting from a monomer mixture comprising:
a) 1 to 50 μmol per gram of matrix of a multifunctional compound comprising at least three reactive functional groups chosen from amines, carboxylic acids and derivatives thereof, the reactive functional groups being identical;
b) lactams and/or amino acids;
c) a multifunctional compound c) chosen from dicarboxylic acids or diamines;
d) a monofunctional compound, the functional group of which is chosen from amines, carboxylic acids and derivatives thereof,
   the functional groups of c) and d) being amines when the functional groups of a) are acids, the functional groups of c) and d) being acids when the functional groups of a) are amines, the ratio in terms of equivalents of the functional groups of a) to the sum of the functional groups of c) and d) being between 1.5 and 0.66 and the ratio in terms of equivalents of the functional groups of c) to the functional groups of d) being between 0.17 and 1.5.

Such a process and such polymers are described in the document U.S. Pat. No. 5,959,069.

According to a third process, the matrix may be obtained by the melt-blending, for example using an extruder, of a polyamide of the type of those obtained by the polymerization of lactams and/or of amino acids, and of a multifunctional compound comprising a core and at least three branches, all the branches of which have identical terminal functional groups chosen from amines, carboxylic acids and derivatives thereof. The polyamide is, for example, nylon-6.

Such production processes are described in documents EP 0 682 070 and EP 0 672 703.

The multifunctional compounds used may be chosen from compounds having a dendritic or tree structure. They may also be chosen from compounds represented by the formula (I):
R1A—z]ₘ (I)
in which:
R₁ is an aromatic or aliphatic, linear or cyclic, hydrocarbon radical containing at least two carbon atoms and possibly including heteroatoms;
A is a covalent bond or an aliphatic hydrocarbon radical containing from 1 to 6 carbon atoms;
Z represents a primary amine functional group or a carboxylic acid functional group; and
m is an integer between 3 and 8.

According to a preferred characteristic, the radical R₁ is either a cycloaliphatic radical, such as the tetravalent cyclohexanonyl radical, or a propane-1,1,1-triyl or propane-1,2,3-triyl radical.

As other radicals R₁ suitable for the invention, mention may be made, by way of example, of substituted or unsubstituted trivalent phenyl and cyclohexanyl radicals, tetravalent diaminopolymethylene radicals with a number of methylene groups advantageously between 2 and 12, such as the radical originating from EDTA (ethylenediaminetetraacetic acid), octovalent cyclohexanonyl or cyclohexanedionyl radicals, and radicals originating from compounds resulting from the reaction of polyols, such as glycol, pentaerythritol, sorbitol or mannitol, with acrylonitrile.

The radical A is preferably a methylene or polymethylene radical, such as the ethylene, propylene or butylene radicals, or a polyoxyalkylene radical, such as the polyoxyethylene radical.

According to a preferred embodiment of the invention, the number m is greater than 3 and advantageously equal to 3 or 4.

The reactive functional group of the multifunctional compound represented by the X—H symbol is a functional group capable of forming an amide functional group.

Mention may be made, as examples of polyfunctional compounds of formula 1, of the compound 2,2,6,6-tetra(β-carboxyethyl)cyclohexanone, the compound diaminopropane-N,N,N′,N′-tetraacetic acid of the following formula: 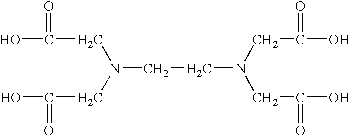
or compounds originating from the reaction of trimethylolpropane or of glycerol with propylene oxide and amination of the end hydroxyl groups; the latter compounds are sold under the trade name JEFFAMINES T® by Huntsman and have the general formula: 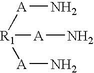
in which:
R₁ represents a propane-1,1,1-triyl or propane-1,2,3-triyl radical,
A represents a polyoxyethylene radical.

Examples of suitable multifunctional compounds are, for example, cited in document U.S. Pat. No. 5,346,984, in document U.S. Pat. No. 5,959,069, in document WO 96/35739 and in document EP 672 703.

The following may more particularly be mentioned:
nitrilotrialkylamines, in particular nitrilotriethylamine, dialkylene-triamines, in particular diethylenetriamine, trialkylenetetramines and tetraalkylene-pentamines, the alkylene preferably being ethylene and 4-aminoethyl-1,8-octanediamine.

Mention may also be made of the dendrimers of formula (II):
(R₂ N—(CH₂)ₙ)₂—N—(CH₂)ₓ—N—((CH₂)ₙ—NR₂)₂ (II)
in which
R is a hydrogen atom or a —(CH₂)ₙ—NR¹₂ group, in which
R¹ is a hydrogen atom or a —(CH₂)ₙ—NR²₂ group, in which
R² is a hydrogen atom or a —(CH₂)ₙ—NR³₂ group, in which
R³ is a hydrogen atom or a —(CH₂)ₙ—NH₂ group,
n being an integer between 2 and 6 and
x being an integer between 2 and 14.
   n is preferably an integer between 3 and 4, in particular 3, and x is preferably an integer between 2 and 6, preferably between 2 and 4, in particular 2.
   Each radical R may be chosen independently of the others. The radical R is preferably a hydrogen atom or a —(CH₂)ₙ—NH₂ group.
   Mention may also be made of multifunctional compounds having 3 to 10, preferably 3 or 4, carboxylic acid groups. Among these, compounds having an aromatic and/or heterocyclic ring are preferred, for example benzyl, naphthyl, anthracenyl, biphenyl and triphenyl radicals, or heterocycles, such as pyridine, bipyridine, pyrrole, indole, furan, thiophene, purine, quinoline, phenanthrene, porphyrine, phthalocyanine and naphthalocyanine. Most particularly preferred are 3,5,3′,5′-biphenyltetracarboxylic acid, acids derived from phthalocyanine and from naphthalocyanine, 3,5,3′,5′-biphenyltetracarboxylic acid, 1,3,5,7-naphthalenetetracarboxylic acid, 2,4,6-pyridinetricarboxylic acid, 3,5, 3′,5′-bipyridyltetracarboxylic acid, 3,5, 3′,5′-benzophenonetetracarboxylic acid, 1,3,6,8-acridinetetracarboxylic acid, and more particularly still trimesic acid and 1,2,4,5-benzenetetracarboxylic acid.
   Mention may also be made of multifunctional compounds whose core is a heterocycle having a point of symmetry, such as 1,3,5-triazines, 1,4-diazines, melamine, compounds derived from 2,3,5,6-tetraethylpiperazine, 1,4-piperazines and tetrathiafulvalenes.
   Mention may more particularly be made of 1,3,5-triazine-2,4,6-tri(aminocaproic acid) (TTACA).

The additives are chosen from fire retardants, pigments or dyes, minerals or organometallics, polyamide polycondensation catalysts, processing aids, such as waxes, and light and UV stabilizers for the polymers.

As examples of fire retardants, mention may be made of phosphorus compounds, such as red phosphorus and coated or passivated red phosphorus; halogenated compounds, such as PDBS and brominated polystyrenes; melamine-based compounds, such as melamine cyanurate, compounds based on magnesium hydroxide or oxide, zinc derivatives, such as zinc borate, zinc oxide or zinc stannate, and antimony dioxide.

The additive may be chosen from organic or organometallic dyes and pigments or mineral dyes. As examples of pigments, mention may be made of titanium dioxide particles, these optionally being coated, and carbon blacks, phthalocyanine-based pigments and azo pigments.

According to one feature of the invention, the proportion by weight of additive in the concentrated polyamide solution is greater than 10%.

According to a particular embodiment, the additive consists of particles based on titanium oxide, in a weight concentration of greater than 65%.

The concentrated solutions according to the invention are prepared by the melt-incorporation of the additive into the matrix. This operation is advantageously carried out using an extruder, in which the material is melted, transported and possibly sheared. The amount of power supplied to the extruder is advantageously less than that needed to carry out the same operation with a matrix based on a linear polyamide. The extrusion conditions are advantageously chosen so that the temperature in the extruder is not too high. Under these conditions, the additive is well dispersed in the matrix, even with a high concentration.

According to one particular embodiment of the invention, the concentrated solution is obtained by introducing, into an extruder, the additive, a multifunctional compound as defined above and a polyamide, during the same extrusion step. The process consists in simultaneously obtaining the star-configured macromolecular chains and introducing the additive into the matrix.

The invention also relates to a process for manufacturing polymer compositions and to polymer compositions comprising the concentrated polyamide solution.

The polymer compositions are obtained by melt-blending a thermoplastic polymer with the concentrated solution, for example using an extruder.

The thermoplastic polymer is preferably chosen from polyamides, more preferably from polymers based on nylon-6 or on nylon-6,6. According to a preferred embodiment of the invention, 99% by weight of the repeat units of the macromolecular chains within the composition are chosen from nylon-6 repeat units and nylon-6,6 repeat units.

The compositions are advantageously obtained by melt-blending the thermoplastic polymer with the concentrated polyamide solution using an extruder. The amount of power supplied to the extruder in order to melt, transport and possibly shear the material is low. The temperature profile within the extruder is advantageously adjusted so as to prevent the thermoplastic polymer from degrading.

Further details or advantages of the invention will become more clearly apparent in the light of the examples given below solely by way of indication.

### EXAMPLES 1 TO 10

Concentrated polyamide solutions based on several additives and on several types of matrix were produced:
Matrix 1: a nylon-6 of 37 relative viscosity measured in formic acid;
Matrix 2: a nylon-6 of 2.7 relative viscosity measured in sulphuric acid;
Matrix 3: a star nylon-6 obtained by polymerizing caprolactam in the presence of 2,2,6,6-tetra-(β-carboxyethyl)cyclohexanone, using a process described in document FR 2 743 077, having a melt flow index of 55 g/10 min at 275° C./100 g;
Additive 1: zinc borate sold by Borax under the name FIREBRAKE ZB;
Additive 2: titanium dioxide particles sold by Kronos Europe under the name KRONOS Cl 220;
Additive 3: organic black pigment sold by Bayer under the name NIGROSINE BASE BA;
Additive 4: inorganic black pigment sold by Degussa under the name PRINTEX 85; and
Additive 5: melamine cyanurate sold by DSM Melapur under the name MELAPUR MC 25.

The additive was incorporated into the matrix using a twin-screw extruder of the Werner and Pfleiderer ZSK40 type with a throughput of 30 kg/h. The concentrated solution was extruded in the form of rods.

The amount of power supplied to the system was evaluated based on the electrical current (in amps).

For each matrix/additive combination, the maximum amount of additive that it was possible to incorporate was determined. This is defined as the amount of additive above which the rod breaks.

The results are given in Table I.

TABLE I

| | | | | | | 6 | 7 (compar- | 8 (compar- | 9 (compar- | 10 (compar- |
|---|---|---|---|---|---|---|---|---|---|---|
| Example | 1 | 2 | 3 | 4 | 5 | (compara-tive) | ative) | ative) | ative) | ative) |
| Matrix | 3 | 3 | 3 | 3 | 3 | 1 | 1 | 2 | 2 | 2 |
| Additive | 1 | 2 | 3 | 4 | 5 | 1 | 2 | 3 | 4 | 5 |
| Extrusion | 240 | 240 | 230-240 | 230-240 | 230-240 | 240 | 240 | 245-255 | 250-260 | 245-255 |
| temperature | | | | | | | | | | |
| (° C.) | | | | | | | | | | |
| Maximum | 75 | 85 | 60 | 40 | 60 | 65 | 80 | 40 | 25 | 40 |
| amount of | | | | | | | | | | |
| additive (%) | | | | | | | | | | |
| Current (A) | 28 | 14 | 35 | 38 | 29 | 38 | 36 | 39 | 42 | 35 |

FIG. 1 shows a photograph of a rod observed in an SEM microscope comprising 80% titanium dioxide in matrix 3. FIG. 2 shows a photograph of a rod observed in an SEM microscope, comprising 80% titanium dioxide in matrix 1. It may be seen that the rod shown in FIG. 1 has, according to the invention, a smooth and crater-free surface.

### EXAMPLE 11

Using an extruder of the same type as that used for Examples 1 to 10, 5% of the concentrated solution of Example 2 was introduced into a nylon-6.

The additive in the composition obtained was extremely well dispersed. FIG. 3 is a photograph of a cross section through a rod obtained. FIG. 4 is a photograph of a rod obtained in a similar manner from a concentrated polyamide solution according to Example 7. Much better dispersion of the additive is observed when using the concentrated solution of Example 2.

### EXAMPLE 12

Using an extruder of the same type as that used for Examples 1 to 10, 5% of the concentrated polyamide solution of Example 1 was introduced into a nylon-6.

The compositions showed excellent dispersion of the additive.

### EXAMPLES 13 AND 14

Concentrated polyamide solutions were produced from a red-phosphorus-based fire retardant sold by Italmatch and from several types of matrix described above.

The additive was incorporated into the matrix using a twin-screw extruder of the Werner and Pfleiderer ZSK70 type, with a throughput of 260 kg/h and a screw rotation speed of 150 rpm. The concentrated solution was extruded in the form of rods.

For each matrix/additive combination, the maximum amount of additive that it was possible to incorporate was determined. This is defined as the amount of additive above which the rod breaks.

The results are given in Table II.

TABLE II

| Example | 13 | 14 (comparative) |
|---|---|---|
| Matrix | 3 | 2 |
| Extrusion temperature (° C.) | 230-250 | 245-275 |
| Amount of additive (%) | 72-75 | 50-53 |
| Die pressure (bar) | 17-19 | 25-28 |
| Maximum amount of | 80 | 60 |
| additive (%) | | |

### EXAMPLES 15 AND 16

Concentrated polyamide solutions were produced from several waxes and from several types of matrix, described above.

The additive was incorporated into the matrix using a twin-screw extruder of the Werner and Pfleiderer ZSK40 type, with a throughput of 30 kg/h.

The concentrated solution was extruded in the form of rods.

Extrusion temperature: 250° C.

For each matrix/additive combination, the maximum amount of additive that it was possible to incorporate was determined. This is defined as the amount of additive above which the rod breaks.

The results are given in Table Ill.

TABLE III

| Example | 15 | 16 (comparative) |
|---|---|---|
| Matrix | 3 | 2 |
| Amount of matrix (%) | 94 | 94 |
| Amount of EBS (ethylene | 3 | 3 |
| bis(stearamide)) (%) | | |
| Amount of calcium stearate (%) | 2 | 2 |
| Amount of aluminium stearate (%) | 1 | 1 |
| Total amount of wax (%) | 6 | 6 |
| Total maximum amount of wax (%) | 12 | 6 |

### EXAMPLES 17 AND 18

Using an extruder of the same type as that used for Examples 15 and 16, 10% of the concentrated solution of Example 15 was introduced into a nylon-6,6 of 2.7 relative viscosity measured in sulphuric acid.

Likewise, 10% of the concentrated solution of Example 16 was introduced into a nylon-6,6 of 2.7 relative viscosity measured in sulphuric acid.

The composition obtained was formed into a collar by moulding using the following operating conditions:
mould temperature (water): 80° C.;
barrel temperature: 320° C.;
hold time: 2 s;
injection rate: 550 cm³/s;
screw speed: 200 rpm;
back-pressure: 5 bar.

The results are given in Table IV

TABLE IV

| Example | 17 | 18(comparative) |
|---|---|---|
| | Identical to | Identical to |
| Concentrated solution | Example 15 | Example 16 |
| Injection pressure (bar) | 111 | 150 |
| Hold pressure | 75 | 75 |
| (bar) | | |
| Cycle time(s) | 9 | 9 |

The composition of Example 17 was easier to mould than the composition of Example 18. Composition 17 also had good mechanical properties, especially a good cold impact strength.

1. Concentrated solution comprising a polyamide-based matrix and an additive selected from the group consisting of fire retardants, pigments, dyes, stabilizers, lubricants, catalysts, processing aids, nucleating agents and mixtures thereof, wherein the matrix is a macromolecular compound comprising
star- or H-configured macromolecular chains comprising a core and at least three polyamide branches linked to the core,
optionally, linear polyamide macromolecular chains, the weight ratio of the star-configured macromolecular chains to the sum of the star-configured and linear macromolecular chains being between 1 and 0.1 and in that the melt flow index of the matrix measured according to the ISO 1133 standard at 275° C. under a load of 100 g is greater than 20 g/10 mm.

2. Concentrated solution according to claim 1, which includes at least 10% by weight of additive.

3. Concentrated polyamide solution according to claim 1, wherein the matrix is obtained by copolymerization starting with a monomer mixture comprising:
a) a multifunctional compound comprising at least three reactive functional groups chosen from amines, carboxylic acids and derivatives thereof, the reactive functional groups being identical,
b) monomers of the following general formulae (IIa) and (IIb):
X—R₂—Y (IIa)
or 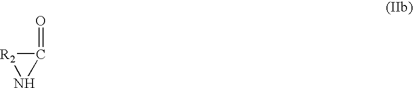
c) optionally, monomers of the following general formula (III):
Z-R₃-Z (III)
in which:
Z represents a functional group identical to that of the reactive functional groups of the multifunctional compound
R₂, R₃, which are identical or different, represent substituted or unsubstituted, aliphatic, cycloaliphatic or aromatic hydrocarbon radicals containing from 2 to 20 carbon atoms and optionally including heteroatoms,
Y is a primary amine functional group when X represents a carboxylic acid functional group, or
Y is a carboxylic acid functional group when X represents a primary amine functional group.

4. Concentrated solution according to claim 1, wherein the matrix is obtained by copolymerization starting from a monomer mixture comprising:
a) 1 to 50 μmol per gram of matrix of a multifunctional compound comprising at least three reactive functional groups selected from the group consisting of amines, carboxylic acids and derivatives thereof, the reactive functional groups being identical;
b) lactams and/or amino acids;
c) a multifunctional compound c) comprising dicarboxylic acids or diamines;
d) a monofunctional compound, the functional group of which is selected from the group consisting of amines, carboxylic acids and derivatives thereof, the functional groups of c) and d) being amines when the functional groups of a) are acids, the functional groups of c) and d) being acids when the functional groups of a) are amines, the ratio in terms of equivalents of the functional groups of a) to the sum of the functional groups of c) and d) being between 1.5 and 0.66 and the ratio in terms of equivalents of the functional groups of c) to the functional groups of d) being between 0.17 and 1.5.

5. Concentrated solution according to claim 1, wherein the matrix is obtained by extruding a polyamide of the type of those obtained by the polymerization of lactams and/or amino acids with a multi-functional compound having at least three reactive functional groups selected from the group consisting of amines, carboxylic acids and derivatives thereof, the reactive functional groups being identical.

6. Concentrated solution according to claim 3, wherein the multifunctional compound or the multifunctional monomer has a dendritic or tree structure.

7. Concentrated solution according to claim 3, wherein the multifunctional compound is represented by the formula (I):
R1A—z]ₘ (I)
in which:
R₁ is an aromatic or aliphatic, linear or cyclic, hydrocarbon radical containing at least two carbon atoms and optionally including heteroatoms;
A is a covalent bond or an aliphatic hydrocarbon radical containing from 1 to 6 carbon atoms;
Z represents a primary amine radical or a carboxylic group; and
m is an integer between 3 and 8.

8. Concentrated solution according to claim 3, wherein the multifunctional compound is selected from the group consisting of 2,2,6,6-tetra-(β-carboxyethyl)cyclohexanone, trimesic acid, 1,3,5-triazine-2,4,6-tri(aminocaproic acid) and 4-aminoethyl-1,8-octanediamine.

9. Concentrated solution according to claim 1, wherein the additive is a fire retardant selected from the group consisting of melamine-based compounds, halogenated compounds, compounds based on magnesium oxide or hydroxide, compounds based on red phosphorus and zinc-based compounds.

10. Concentrated solution according to claim 1, wherein the additive is a pigment or a mineral dye.

11. Concentrated solution according to claim 10, wherein the additive is an organic or organometallic dye.

12. Concentrated solution according to claim 1, wherein the additive is selected from the group consisting of heat stabilizers and light or UV stabilizers for polyamides.

13. Process for manufacturing a concentrated polyamide solution according to claim 1, comprising introducing the matrix and the additive into an extruder and in extruding the melted blend.

14. Process for manufacturing a thermoplastic polymer composition by melt-blending a concentrated solution with a thermoplastic polymer, wherein the concentrated solution is a concentrated solution according to claim 1.

15. Process according to claim 14, wherein the thermoplastic polymer is polyamide-based.

16. Polymer composition comprising a thermoplastic polymer and at least one additive, which is obtained by melt-blending a thermoplastic polymer with a concentrated polyamide solution according to claim 1.

17. Polymer composition according to claim 16, wherein the macromolecular units present in the composition are selected from the group consisting of nylon-6 repeat units and nylon-6,6 repeat units.
